(19) United States
(12) Patent Application Publication
(10) Pub. No.: US 2007/0281537 A1
(43) Pub. Date: Dec. 6, 2007

(54) Joining an electrical conductor with a connector

(75) Inventor: Marcel Perle, Feldkirch (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/810,138

(22) Filed: Jun. 4, 2007

(30) Foreign Application Priority Data
Jun. 3, 2006 (DE) 102006026112.7

(51) Int. Cl. H01R 4/24

(52) U.S. Cl. 439/404

(57) ABSTRACT

An electrical conductor is joined to a connector by first juxtaposing the conductor with the connector, then deforming the juxtaposed conductor and connector to connect the conductor mechanically to the connector, and also welding the juxtaposed conductor to the connector.

### FIELD OF THE INVENTION

The present invention relates to making a permanent joint between an electrical conductor and a connector. More particularly this invention concerns a method of and apparatus for permanently fixing a connector on an end of a conductor of a cable.

### BACKGROUND OF THE INVENTION

It is often necessary to join a conductor of a wire with a connector. The connector is frequently a plug or a socket. In general, when it is not easily possible to lay a finished cable containing plugs, the cable alone is pulled to the destination site, and only then is an electrical contact part fitted to the end of the conductor, typically by crimping. A strong mechanical connection is made between the connector and the conductor, usually after stripping a short piece of the insulating sheath off the cable end. Then the stripped conductor is fitted to a conductive part of the plug or socket, and the connection is made by a crimping tool. The connection is established by compressing the connector and the conductor together, typically with a U-shaped or tubular part of the connector at least partially surrounding the conductor.

As a deforming process, crimping is a mechanical joining procedure in which two components are connected to one another by plastic deformation. A crimped connection is detachable only to a limited extent, and usually cannot be repaired. The mechanical connection is quite strong, but there are still electrical losses across a crimped connection.

### OBJECTS OF THE INVENTION

It is therefore an object of the present invention to provide an improved system for joining an electrical conductor with a connector.

Another object is the provision of such an improved system for joining an electrical conductor with a connector that overcomes the above-given disadvantages, in particular that forms a permanent, mechanically strong, and no-loss connection between the conductor and the connector.

### SUMMARY OF THE INVENTION

An electrical conductor is joined to a connector by first juxtaposing the conductor with the connector, then deforming the juxtaposed conductor and connector to connect the conductor mechanically to the connector, and also welding the juxtaposed conductor to the connector.

The electrical connection is greatly improved by additionally welding the connection site in a welding process subsequent to or simultaneously with the deforming process. By means of the deforming process the conductor is relieved of tension and is made gas-tight, thereby securing the welding site and forming an electrical connection that is virtually 0 ohms.

In one design according to the invention, the deforming process and the welding process are combined into a single work step, thereby minimizing the costs of the additional welding procedure.

The conductor is preferably inserted together with the connector into the deforming tool and the deforming process is carried out, and immediately after the deforming process or simultaneously therewith the deforming tool is heated in the vicinity of the juxtaposed conductor and connector so that the deformed connector is welded to the conductor in this region. Alternatively, depending on the welding method, it is also possible that the tool does not get hot enough to create a combustion hazard during welding.

To simplify the welding procedure, in the design according to the invention the conductor is tinned in the region of the deforming, that is covered with layer of solder. However, it is not absolutely necessary for the conductor to be tinned. This depends on the contacting partners or their materials; when these are selected so as to have good mutual connection properties, solder may be omitted.

In the design according to the invention, the connector is a plug or a socket, and the conductor is preferably a flexible lead.

The deforming process is preferably a crimping process.

A deforming tool according to the invention for connecting a conductor to a connector by use of a deforming process, in particular for carrying out the method described above, is characterized according to the invention in that in the vicinity of the location on the connector and conductor that is deformed the deforming tool has a heating element by means of which the region to be shaped may be heated.

### BRIEF DESCRIPTION OF THE DRAWING

The above and other objects, features, and advantages will become more readily apparent from the following description, reference being made to the accompanying drawing in which:

FIGS. 1-3 are diagrammatic views illustrating the three principal steps of the instant invention.

### SPECIFIC DESCRIPTION

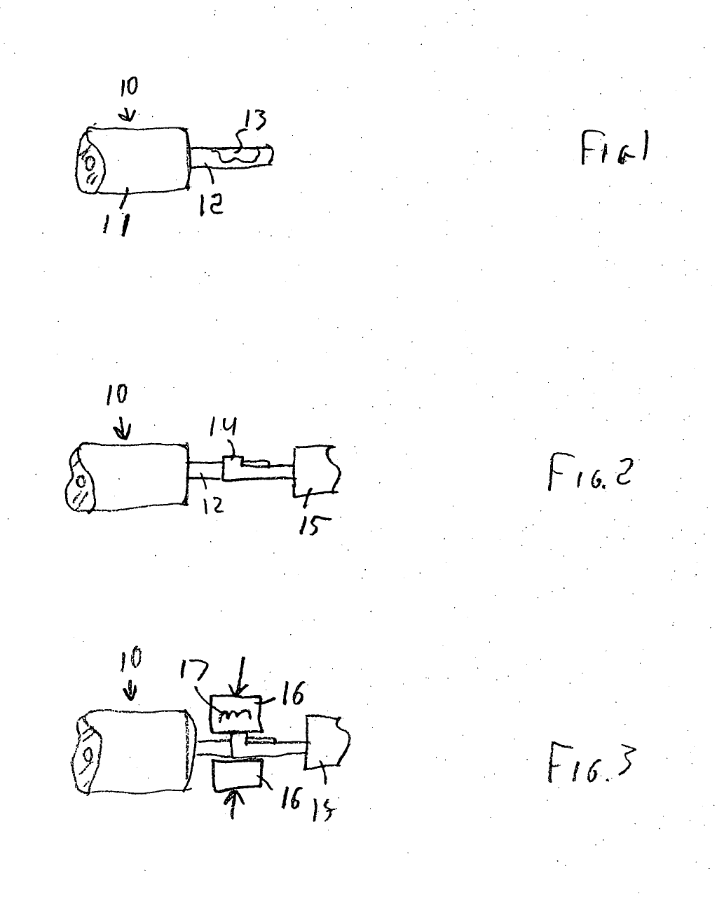

As seen in FIG. 1 a cable or wire 10 having a copper conductor 11 and insulating sheath 12 is first stripped to expose a short length of the conductor 11, which is then coated at lest partially with solder 13.

Then as shown in FIG. 2 the tinned conductor 12 is fitted in a U-shaped seat 14 formed by a pair of arms of a copper-coated connector 15, that here may be part of a plug or socket or other fitting adapted to form a further connection.

Finally as shown in FIG. 3, the seat 14 is compressed between a pair of jaws 16 so as to mechanically crimp the seat 14 around the tinned conductor 12. One of the jaws 16 is provided with a heater to melt the solder coating 13. The solder bonds the conductor 12 in a gas-tight manner to the connector 14 and the crimping forms a permanent mechanical connection between them.

I claim:

1. A method of joining an electrical conductor to a connector, the method comprising the steps of:
a) juxtaposing the conductor with the connector;
b) deforming the juxtaposed conductor and connector to connect the conductor mechanically to the connector; and
c) welding the juxtaposed conductor to the connector.

2. The joining method defined in claim 1 wherein the steps b) and c) are done simultaneously.

3. The joining method defined in claim 1 wherein step a) is done by
fitting the conductor and connector to a tool and
compressing the conductor and connector together with the tool.

4. The joining method defined in claim 3 wherein step c) is done by heating the tool.

5. The joining method defined in claim 3 wherein the tool is a crimping tool.

6. The joining method defined in claim 1, further comprising the step before step b) of
a′) tinning the conductor.

7. The joining method defined in claim 1 wherein the connector is a plug or socket.

8. The joining method defined in claim 1 wherein the conductor is a conductive strand in an insulating sheath.

9. A tool for carrying out the method of claim 1, the tool comprising
a pair of jaws for compressing together the connector and conductor; and
means for heating at least one of the jaws.
